(19) United States
(12) Patent Application Publication
(10) Pub. No.: US 2025/0249688 A1
(43) Pub. Date: Aug. 7, 2025

(54) RECORDING DEVICE

(71) Applicant: CANON KABUSHIKI KAISHA, Tokyo (JP)

(72) Inventors: Sae MOGI, Kanagawa (JP); Takeshi MURASE, Kanagawa (JP); Masaki NITTA, Kanagawa (JP); Hiroshi TAIRA, Tokyo (JP); Hiroshi KAWAFUJI, Tokyo (JP); Shunnosuke KOSEKI, Kanagawa (JP)

(21) Appl. No.: 19/023,986

(22) Filed: Jan. 16, 2025

(30) Foreign Application Priority Data
Feb. 7, 2024 (JP) 2024-017443

(51) Int. Cl. B41J 2/18; B41J 2/14; B41J 2/175

(52) U.S. Cl. CPC B41J 2/18; B41J 2/14153; B41J 2/17596

(57) ABSTRACT

A recording device including a recording head, a circulation unit and a control unit is used. The recording head includes an ejection port and a pressure chamber filled with ink, and performs recording operation by ejecting ink from the ejection port. The circulation unit performs circulation operation to circulate ink through a circulation path including the pressure chamber. The control unit acquires temperature information, which is information on temperature of the recording head, in a state where the circulation unit is performing the circulation operation, and determines a circulation state of the ink in the circulation path based on the information on the temperature.

### BACKGROUND OF THE INVENTION

### Field of the Invention

The present invention relates to a recording device where ink circulates through a recording head and a circulation path, including the recording head, and a control method for the recording device.

### Description of the Related Art

In an inkjet printer, a problem may arise in which the viscosity of ink around an ejection port of a recording head increases due to the evaporation of volatile components in the ink from the ejection port. A known method for preventing this problem is circulating ink, which is to be supplied to the recording head, within the circulation path. However if the ink is circulated, fresh ink is always applied to the ink ejection port, water is evaporated through the ejection port, and the concentration of ink in the entire circulation path gradually increases, which is also a problem.

In order to prevent the increase of the concentration of ink in the entire circulation path and the evaporation of volatile components in the ink around the ejection port, Japanese Patent Application Publication No. 2017-121784 discloses a technique to stop the circulation of ink when recording ends.

### SUMMARY OF THE INVENTION

In some cases, the recording head may include a heater to increase the temperature of the recording head and maintain the temperature at a high temperature state. Also in some cases, the recording head may include a heating element to foam the ink by thermal energy. Therefore if the recording operation continues for a long time, the temperature of the recording head may not sufficiently drop even after the heating operation of the recording head stops, because of the influence of the stored heat in members of the recording head caused by the heater for heating the recording head and heating elements, and the temperature around the ejection port may remain in a high state.

Normally when a print start signal is received, driving of a circulation pump starts and ink is circulated. However in some cases, even if the driving of the circulation pump is electrically operating in a normal state, normal ink circulation may not be performed around the nozzle actually, due to the clogging of foreign substances or due to bubbles at the ejection port and vicinity thereof. If this abnormal ink circulation around the nozzle is not corrected, ink around the ejection port thickens, which influences ink ejection.

With the foregoing in view, it is an object of the present invention to determine whether the circulating state of ink is normal in the recording device where ink circulates through the circulation path.

The present invention provides a recording device, comprising:
a recording head that includes an ejection port configured to eject ink, and a pressure chamber filled with ink to be ejected from the ejection port, and performs recording operation by ejecting ink from the ejection port;
a circulation unit configured to perform circulation operation to circulate ink through a circulation path including the pressure chamber; and
a control unit, wherein
the control unit
acquires temperature information, which is information on temperature of the recording head, in a state where the circulation unit is performing the circulation operation, and
determines a circulation state of the ink in the circulation path, based on the information on the temperature.

According to the present invention, in the recording device where ink circulates through a circulation path, it can be determined whether the circulation state of the ink is normal.

Further features of the present invention will become apparent from the following description of exemplary embodiments with reference to the attached drawings.

### BRIEF DESCRIPTION OF THE DRAWINGS

FIG. 1 is a perspective view of an inkjet recording device;

FIG. 2 is a schematic perspective view of a recording head;

FIG. 3 is a schematic diagram depicting a configuration of a recording head and a buffer tank;

FIG. 4 is a diagram depicting a configuration of ejection ports and passages inside a recording element substrate, and a flow of ink;

FIG. 5 is a perspective view of the recording element substrate in a direction vertical to the XY plane;

FIG. 6A is an enlarged view of a part of the recording element substrate, and FIG. 6B is a cross-sectional view at a sectioned line indicated in FIG. 6A;

FIG. 7 is a block diagram of a control system installed in the inkjet recording device;

FIG. 8 is a flow chart of a circulation detection operation according to Embodiment 1;

FIG. 9 is an image diagram depicting a recording head temperature change transition after the end of the recording operation;

FIGS. 10A to 10C are tables to determine a specified value α in Embodiment 1;

FIG. 11 is a flow chart of a circulation detection operation according to a modification;

FIG. 12 is a flow chart of a circulation detection operation according to Embodiment 2;

FIG. 13 is a table to determine a specified value α in Embodiment 2;

FIG. 14 is a flow chart of a circulation detection operation according to Embodiment 3; and

FIG. 15 is a flow chart of a circulation detection operation according to Embodiment 4.

### DESCRIPTION OF THE EMBODIMENTS

Preferred embodiments of the present invention will now be described in detail with reference to the drawings. Here the dimensions, materials and shapes of the components and relative positions thereof described in the embodiments are not intended to limit the scope of the invention thereto, unless otherwise specified. A material, a shape and the like of a member described once remain unchanged in the subsequent description unless otherwise specified. For configurations and steps that are not especially illustrated or described, a conventional technique or publicly known technique in this technical field can be applied. The present invention is not limited to these embodiments along, and all the combinations of the features described in the embodiments are not essential for the present invention to solve a problem.

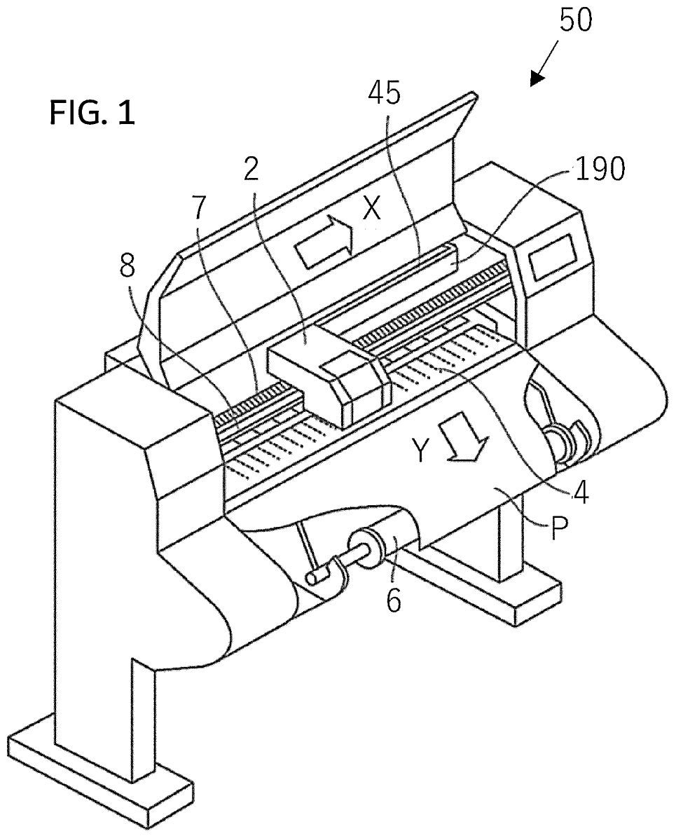

An embodiment of the present invention will now be described in detail with reference to the drawings. FIG. 1 is an external view of an inkjet type recording device 50 (hereafter also called “printer”) according to an embodiment. The recording device 50 is a serial scanning type printer, which scans an image with a recording head in an intersecting direction (X direction), orthogonal to a conveying direction (Y direction) of a recording medium P, whereby the image is recorded. In the following, a recording device 50, which includes this serial type recording head, will be described as an example. However the present invention is not limited to this, but is applicable to a recording element substrate, a recording head, or a recording device in general, in which the problem to be solved by the present invention may be generated. For example, the present invention is also applicable to a line head type recording head.

An outline of the configuration of the recording device 50 and operation thereof during recording will be described with reference to FIG. 1. A recording medium P, on which an image is recorded, is held by a spool 6. First the recording medium P is conveyed in the Y direction by the spool 6 using a conveying roller (not illustrated) which is driven by a conveying motor via a gear. On the other hand, at a specified conveying position, a carriage motor (not illustrated) performs scanning with a carriage unit 2 along a guide shaft 8, which extends in the X direction. The method for transferring the driving force from the carriage motor to the carriage unit 2 is not critical. For example, a carriage belt may be used, or a combination of: a lead screw which is rotary-driven by the carriage motor and extends in the X direction; and an engaging portion which is disposed in the carriage unit 2 and engages with a groove of the lead screw, may be used.

In this scanning process, liquid (e.g. ink) is ejected from the ejection ports of a recording head (described later) installed in the carriage unit 2, whereby an image having a predetermined band width corresponding to a range of the ejection port array is recorded. A timing of ejecting the liquid is controlled based on a position signal acquired by an encoder 7. In the ejection operation of this embodiment, it is assumed that the scanning speed is 40 inch/sec and the resolution is 600 dpi ( 1/600 inch). After recording is performed for one band width, the recording medium P is conveyed, and recording is performed for the next band width. By repeating this, a desired image is formed on the recording medium P. An image may be recorded on a unit region of the recording medium P by a single scanning step (single pass recording), or an image may be recorded by a plurality of times of scanning steps (multi-pass recording).

The supplied recording medium P is held between a paper feeding roller and a pinch roller (not illustrated), and is conveyed to a recording position (main scanning region of the recording head) on a platen 4. Normally in a stopping state, a face surface of the recording head is capped, and the cap is removed before recording so that the recording head and the carriage unit 2 can be used for scanning. Then when data for one scanning step is stored in a buffer, the carriage unit 2 is driven and scanning is performed by the carriage motor, and recording is performed as mentioned above.

Here one end of a flexible wiring board 190, to supply a driving pulse, a hand temperature adjustment signal, and the like for ejection driving, is installed on the recording head. The other end of the flexible wiring board 190 is connected to a control unit, including a control circuit (e.g. CPU), to execute control of this printer. In the vicinity of the control unit, a thermistor (not illustrated), which is a temperature sensor to detect an ambient temperature inside the inkjet recording device, is disposed.

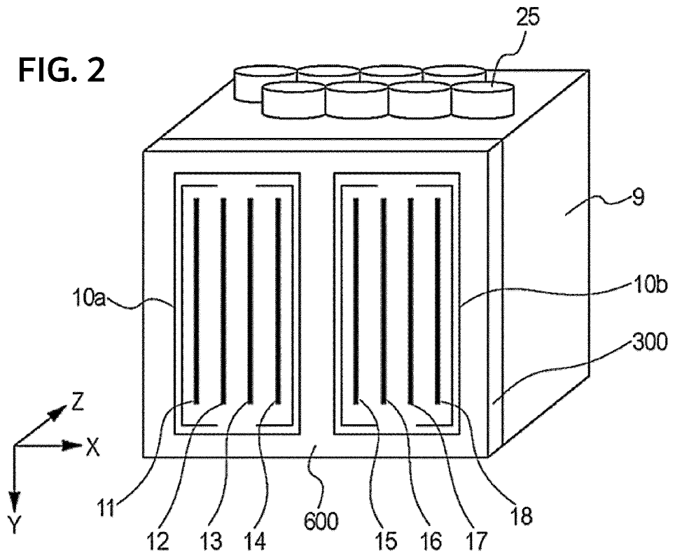

FIG. 2 is a schematic perspective view of a recording head 9 according to this embodiment. In the recording head 9, a joint portion 25 is formed, and an ink supply tube is connected to the joint portion 25. The ink is pressurized and supplied from an ink tank (not illustrated), reaches into the recording head 9 via the supply tube, then passes through a filter and flows into a passage. In the recording device 50 according to this embodiment, a mode of circulating ink inside the recording head 9 is described as an example, but the ink circulation mode is not especially limited. The circulation path of the ink may include a region outside the recording head 9.

On the ejection port forming surface, which is a surface facing the recording medium P of the recording head 9, two recording element substrates 10a and 10b, formed of semiconductor or the like, are installed. On the recording element substrates 10a and 10b, ejection port arrays 11 to 18 are formed in the Y direction, which is orthogonal to the X direction respectively, so that ink can be ejected for each of a plurality of ink types. In this embodiment, a plurality of ink colors can be ejected.

At positions inside the recording element substrates 10a and 10b facing the ejection port arrays 11 to 18 respectively, recoding element arrays are formed as described later. The recording element substrates 10a and 10b are fixed to a support member 300, which is formed of alumina, resin or the like, by an adhesive material. Further, the recording element substrates 10a and 10b are electrically connected to an electric wiring member 600 where wiring is disposed, so as to communicate with the control unit via this electric wiring member 600.

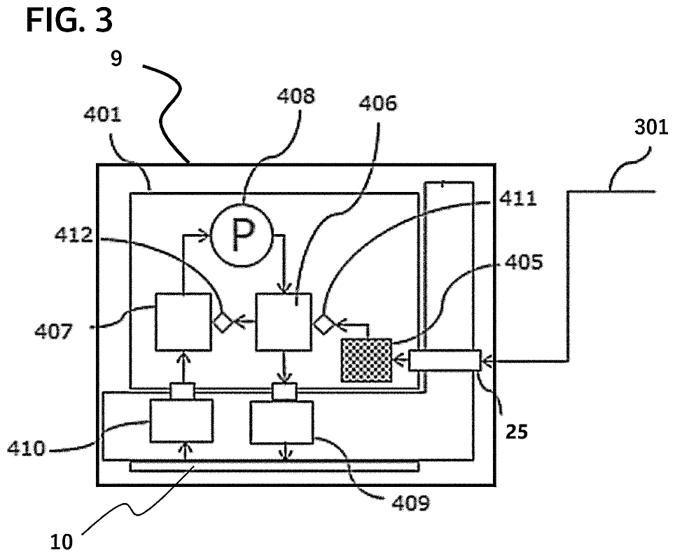

FIG. 3 is a schematic diagram depicting a configuration of the recording head 9 and a buffer tank 401. A method of supplying ink to the recording head 9 and the buffer tank 401, and a method of circulating ink in the ejection port, according to this embodiment, will be described. FIG. 3 is a schematic diagram of a passage of one ink color, but buffer tanks and passages for a plurality of colors may be disposed in one recording head, and in this case, a plurality of configurations in FIG. 3 exist. Here the recording element substrates 10a and 10b are described as a recording element substrate 10, without make a distinction.

A supply tube 301 is connected to a joint portion 25 of the recording head through the inside of the carriage unit 2, communicating with the buffer tank 401. The supplied ink passes through a filter 405, reaching a first pressure control member 406 via a passage inside the buffer tank 401. The first pressure control member 406 is connected with a second pressure control member 407 via two passages (a passage including a valve 412 and a passage through a pump 408).

At the inflow ports of the first pressure control member 406 and the second pressure control member 407, valves 411 and 412, which open at a predetermined negative pressure, are disposed respectively. The inflow port of the first pressure control member 406 is disposed on the passage from the filter 405. The inflow port of the second pressure control member 407 is disposed on the passage from the first pressure control member 406. The negative pressure at which the valve 412 of the inflow port of the second pressure control member 407 opens is set to be higher than the negative pressure at which the valve 411 of the first pressure control member opens.

To supply the ink to the recording element substrate 10, the ink first flows in through the joint portion 25, then, through the first pressure control member 406, reaches a common supply passage 409 configured inside the recording head. Then from the common supply passage 409, the ink is supplied to an individual supply passage (described later) of one or a plurality of ejection port arrays disposed inside the recording element substrate 10. The ink not ejected flows into an individual recovery passage (described later) inside the recording element substrate 10 via the vicinity of the ejection ports. Then the ink returns to the second pressure control member 407 via a common recovery passage 410 configured inside the recording head 9.

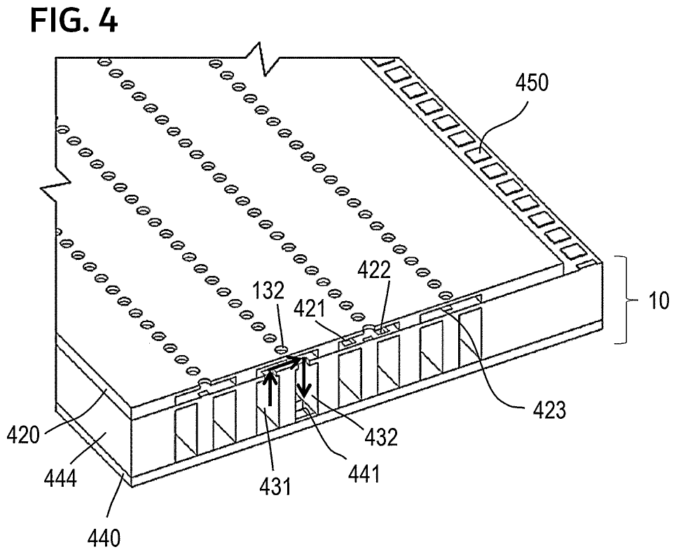

FIG. 4 is a diagram depicting a configuration of ejection ports and passages formed inside the recording element substrate 10, and the flow of the ink. The recording element substrate 10 is configured such that an orifice plate 420 is layered on one surface of a substrate 444, and a cover plate 440 is layered on the other surface of the substrate 444. Ejection ports 132 are formed in the orifice plate 420. The ink supplied to the passage is maintained at negative pressure, so that a meniscus is formed on the surface of the ejection port.

On both sides of the ejection port 132, an inflow port 421 and an outflow port 422 are formed respectively for two passages. In this embodiment, one inflow port 421 and one outflow port 422 are disposed for two ejection ports 132 respectively, as illustrated in FIG. 4. The number of inflow ports 421 and the number of outflow ports 422 are not especially limited, and one inflow port 421 and one outflow port 422 may be disposed for one ejection port 132, or one inflow port 421 and one outflow port 422 may be disposed for three or more ejection ports 132. The inflow port 421 and an outflow port 422 are connected to an individual supply passage 431 and an individual recovery passage 432, which are formed in the ejection port array direction respectively. The individual supply passage 431 and the individual recovery passage 432 are covered by the cover plate 440, and are connected to the common supply passage 409 and the common recovery passage 410 of the recording head 9 via an opening portion 441 on the cover plate 440. A number of opening portions 441 disposed for each individual supply passage 431 and each individual recovery passage 432 is at least one. The number of opening portions 441 disposed for the supply passage and for the receive passage may be the same or may be different.

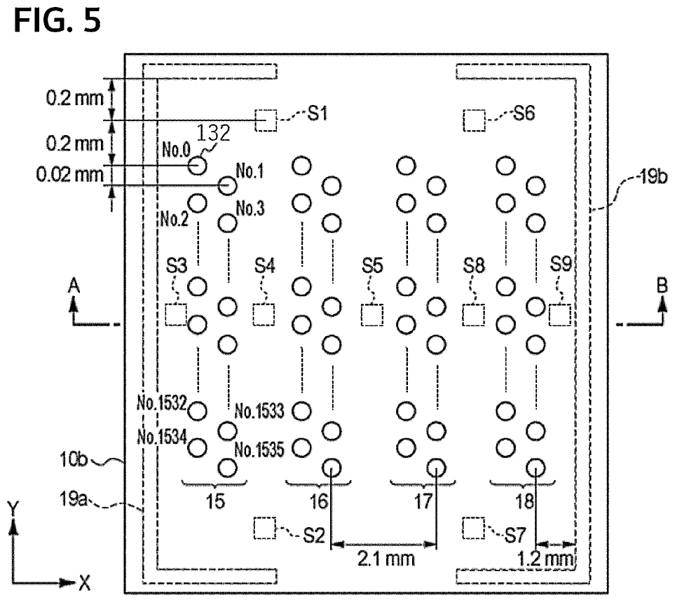

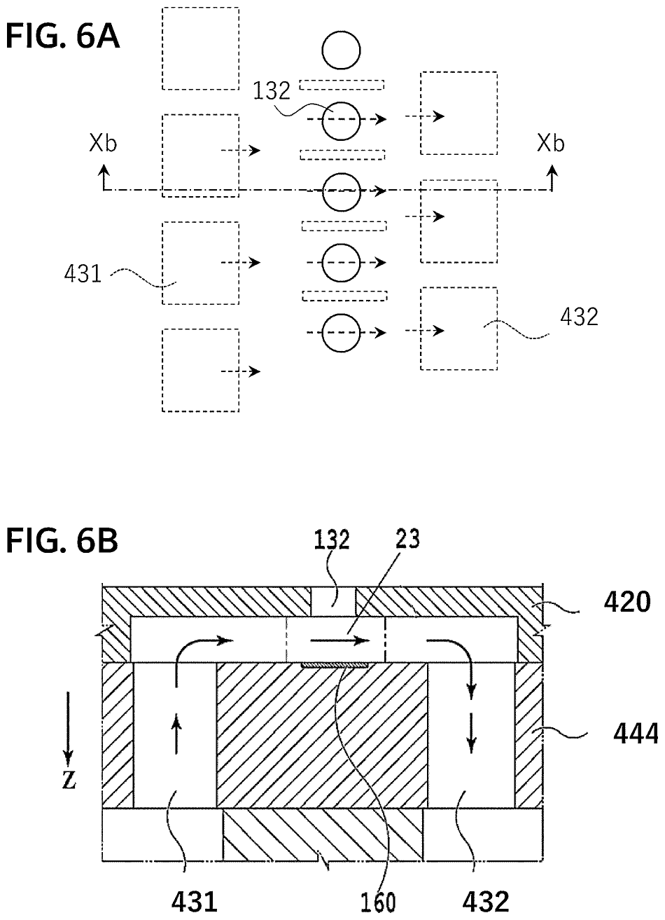

Configuration of Recording Element Substrate FIG. 5 is a perspective view of the recording element substrate 10b in a direction vertical to the XY plane. FIG. 6A is a schematic plan view enlarging a part of the recording element substrate 10b. FIG. 6B is a schematic cross-sectional view at the section line Xb-Xb in FIG. 6A.

Each of the ejection port arrays 15 to 18 in this embodiment includes two arrays. These two arrays are disposed respectively in the Y direction (array direction) in a state of facing each other, being shifted from each other by one dot at 1200 dpi (dot/inch). There are 768 ejection ports 132 in one array, and a total of 1536 ejection ports 132 are disposed in the two arrays.

As illustrated in FIG. 6B, an ejection element 160 is disposed at a position facing each ejection port 132 in the Z direction. The ejection element 160 is an electro-thermal conversion element, and is also called a “main heater” hereinbelow. This ejection element 160 is also arrayed in the Y direction along the array of the ejection port 132. In this embodiment, 1200 dpi is equivalent to about 0.02 mm. By applying a driving pulse to this ejection element 160, thermal energy, to eject ink from the ejection port, can be generated. The ejection element 160 here is not limited to an electro-thermal conversion element, but may be a piezoelectric element, for example. An operation unit in the ink ejection, including a set of the ejection port 132 and the ejection element 160, is also called a “recording element” hereinbelow.

In the following, to simplify description, a recording element, which includes a set of the ejection port 132 and the ejection element 160 located on the most downstream side in the Y direction, out of the 1536 ejection ports 132 and 1536 ejection elements 160 included in a certain ejection port array, is collectively called a “recording element No. 0”. Further, a set of the ejection port 132 and the ejection element 160 located on the immediate upstream side of the recording element No. 0 in the Y direction is called a “recording element No. 1”. Thereafter a recording element No. is specified in the same manner, and a set of the ejection port 132 and the ejection element 160 located on the most upstream side in the Y direction is collectively called a “recording element No. 1535”.

On the recording element substrate 10b, a plurality of temperature detection elements S (S1 to S9) are evenly disposed as the temperature sensors to detect the temperature of the ink in the vicinity of the ejection elements 160 around the recording element substrate 10b. FIG. 5 indicates the temperature detection elements S in transmissive states. The positions where the temperature detection elements S are disposed are not limited to this, as long as the temperature of the ink can be measured.

In this embodiment, the temperature of the ink in the ejection port near the temperature detection element S is approximately the same as the temperature of the recording element substrate 10b at the position where this temperature detection element S is disposed. Hence the temperature of the recording element substrate 10b is regarded as the temperature of the ink.

Further, on the recording element substrate 10b, heating elements 19a and 19b, which can heat the recording element substrate, are disposed separately from the ejection elements 160. Immediately before starting the recording operation, the control unit performs temperature adjustment control to heat the ink to a predetermined temperature using the heating elements 19a and 19b. Thereby the change of viscosity of the ink inside the recording head 9 is prevented, and a constant viscosity can be maintained without the influence of the environmental temperature.

### Configuration of Nozzle Circulation

In the recording element substrate 10b, a pressure chamber 23, in which ink is filled, is disposed in a vicinity of a joined portion of the orifice plate 420 and the substrate 444. The ejection port 132 is disposed so as to penetrate through the orifice plate 420 from the pressure chamber 23. The above mentioned ejection element 160 is disposed on the pressure chamber 23 at a position facing the ejection port 132. The pressure chamber 23 is in a space facing the ejection element 160 in the Z direction, and the ink filled in the pressure chamber 23 is ejected through the ejection port 132 when the ejection element 160 is driven. In the recording element substrate 10b, the individual supply passage 431 connected to the common supply passage 409 and the individual recovery passage 432 connected to the common recovery passage 410 are formed in the substrate 444 for each ejection port 132.

The above mentioned configuration allows generating a flow of ink in the recording element substrate 10b, where the ink flows in from the common supply passage 409 of which negative pressure is relatively weak (absolute value of the pressure is relatively high), and the ink flows out to the common recovery passage 410 of which negative pressure is relatively strong (absolute value of the pressure is relatively low). Specifically, the ink flows in a sequence of: the common supply passage 409->individual supply passage 431->pressure chamber 23->individual recovery passage 432->common recovery passage 410.

If the ink inside the pressure chamber 23 is ejected by the ejection element 160 that is driven here, a part of the ink moving from the common supply passage 409 to the common recovery passage 410 is ejected through the ejection port 132, and is discharged from the recording head 9. The ink which is not ejected through the ejection port 132, on the other hand, is recovered to the second pressure control member 407 via the common recovery passage 410.

In a state where the inside of the recording head is filled with ink at an appropriate negative pressure such that a meniscus is held on the ejection port surface, the valve 411 at the inflow port of the first pressure control member 406 is closed, and the ink does not flow into the first pressure control member 406. However if the negative pressure of the first pressure control member 406 increases, as in the case where strong negative pressure is applied to the ejection port by a suction operation using the cap of a recovery processing device, or a case where ink is ejected through the ejection port, the valve 411 of the inflow port opens and ink flows into the first pressure control member.

As illustrated in FIG. 3, the first pressure control member 406 and the second pressure control member 407 are connected to the pump 408. When this pump 408 is driven, the ink is transferred from the second pressure control member 407 to the first pressure control member 406 via the pump 408. Then the negative pressure in the second pressure control member 407 increases and the valve 412 of the second pressure control member 407 opens, whereby ink flows back from the first pressure control member 406 to the second pressure control member 407. At this timing a pressure difference is generated between the first pressure control member 406 and the second pressure control member 407, hence the ink flows from the first pressure control member 406 and passes in the sequence of: the common supply passage 409->cover plate opening portion 441->individual supply passage 431 of each ejection port array->inflow port 421. Here a part of the ink flows into the ejection port 132.

Then the ink flows from the ejection port 132 and passes in the sequence of: the outflow port 422->individual recovery passage 432->cover plate opening portion 441->common recovery passage 410, and returns to the second pressure control member 407. The flow rate of the pump, the pressure loss of the passage between the first and second pressure control members, and the open/close force of the valve of the inflow port are adjusted such the negative pressure inside the ejection port and the ink flow speed are in a range to maintain the meniscus. By the above configuration and control, ink around the ejection port 132 is moved in accordance with the driving of the pump 408. This suppresses the increase of viscosity of the ink caused by drying inside the ejection port during the recording operation, whereby deterioration of the ejection characteristics of the ink can be prevented. Here the recording element substrate 10b has been described in detail, but the recording element substrate 10a also has a similar configuration.

### Control System Configuration

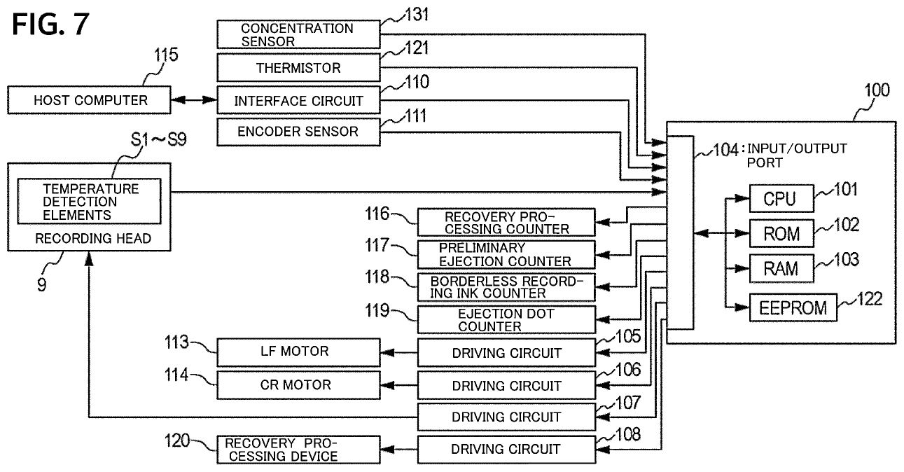

FIG. 7 is a block diagram depicting a configuration of a control system installed in the recording device 50 according to this embodiment. A main control unit 100 includes: a CPU 101, a ROM 102, a RAM 103, an input/output port 104, and an EEPROM 122. The CPU 101 executes such processing as arithmetic operation, control, determination and setting. The ROM 102 functions as a memory to store control programs and the like to be executed by the CPU 101. The RAM 103 is used as a buffer to store binary recording data indicating the ejection/non-ejection of ink, and as a work area for processing by the CPU 101. Further, the RAM 103 can also be used as storage means for storing the amount of ink in the main tank before and after the recording operation and the available capacity of the sub-tank. The input/output port 104 handles the input/output of signals. The EEPROM 122 is used as a non-volatile memory.

To the input/output port 104, driving circuits 105, 106, 107 and 108 for a conveying motor (LF motor) 113 which drives the conveying roller, a carriage motor (CR motor) 114, the recording head 9, a recovery processing device 120 and the like are connected. These driving circuits 105, 106, 107 and 108 are controlled respectively by the main control unit 100. Further, to the input/output port 104, various sensors, such as the temperature detection elements S1 to S9, which are diode sensors to detect the temperature of the recording head 9, an encoder sensor 111 fixed to the carriage unit 2, and a thermistor 121 to detect an ambient temperature (environmental temperature) inside the recording device 50, are connected. The main control unit 100 is connected to a host computer 115 via an interface circuit 110.

The driving circuit 107, which functions as a signal transmission unit to the recording head, transmits/receives the driving pulse to be applied, recording data for recording, and the like. These data are transferred via the above mentioned flexible wiring board 190.

The recovery processing counter 116 counts a number of times of driving the ejection element 160 for recovery processing, in which the recovery processing device 120 forcibly ejects ink from the recording head 9. The preliminary ejection counter 117 counts a number of times of driving the ejection element 160 for preliminary ejection, which is performed before the start of recording, at the end of recording, or during recording. The borderless recording ink counter 118 counts a number of times of driving the ejection element 160 to eject ink out of the recording medium region when the borderless recording is performed. The ejection dot counter 119 counts a number of times of driving the ejection element 160 during recording. The total of the count values calculated by these counters 116 to 119 is stored in the EEPROM 122 as a total of a number of times of driving the ejection element 160 of each ejection element array since the recording head 9 was installed in the recording device 50. In this embodiment, the total of the number of times of driving the ejection element 160 is calculated for each ejection element array. Besides the total of the number of times of driving the ejection element, various other information may be stored in the EEPROM 122.

### Embodiment 1

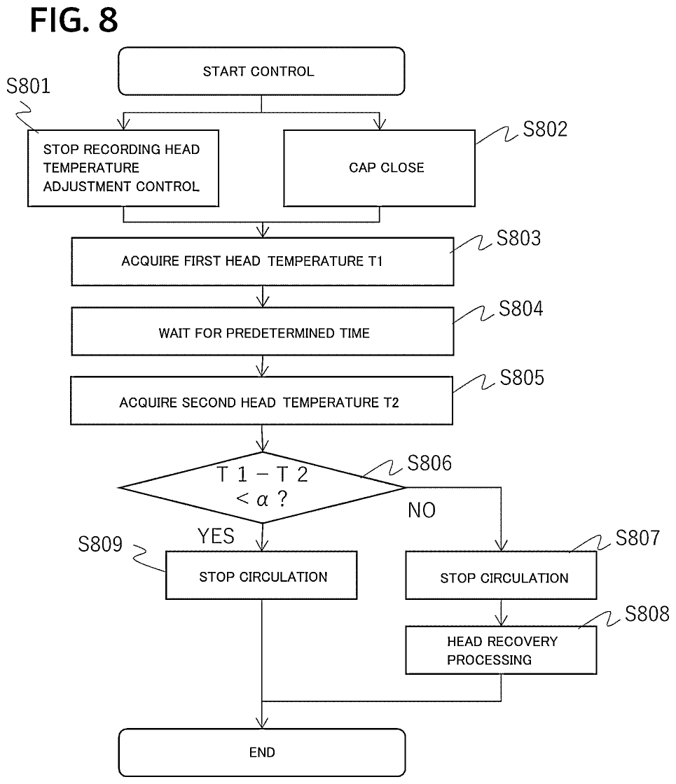

The circulation detection operation, which is characteristic of Embodiment 1, will now be described. FIG. 8 is a flow chart of a circulation detection operation sequence which is performed by the main control unit 100. This flow chart is started after the recording operation by the recording head 9 ends. As mentioned above, the circulation operation has been started during the recording operation, in order to suppress the increase of viscosity of the ink caused by drying inside the ejection port, and to prevent deterioration of the ejection characteristic of the ink. Therefore when this flow chart is started, the circulation operation has already started.

In step S801, the main control unit 100 stops driving the heating element 19 to heat the recording element substrate 10, and stops the temperature adjustment control of the recording head 9.

In step S802, the main control unit 100 allows a cap portion (not illustrated) to contact with the ejection port surface of the recording head 9, and sets the cap member to a cap close state. After the recording operation ends, the processing steps in S801 and S802 are performed in parallel, and when the processing steps S801 and S802 complete, processing advances to S803.

In step S803, the main control unit 100 acquires information on the temperature (temperature information) of the recording head 9 from the plurality of temperature detection elements S1 to S9 inside the recording element substrate. Hereafter T1 is called a first head temperature. This step corresponds to acquiring the first temperature information at a first timing. In this embodiment, a maximum value of the temperature values detected by the temperature detection elements S1 to S9 is determined as the temperature of the recording head 9. The method for determining the temperature of the recording head 9 is not limited to the above mentioned method. The average of the detected values by the plurality of temperature detection elements S1 to S9 may be determined as the temperature of the recording head 9, or the temperature of the recording head 9 may be determined based on the temperatures of other members constituting the recording head 9. The temperature of the recording head 9 may also be determined by selecting a temperature detection element disposed in the vicinity of the opening portion, out of the plurality of temperature detection elements S1 to S9 inside the recording element substrate. This is because the passage resistance is low and ink flow is easily generated in the vicinity of the opening portion 441, hence the temperature changes depending on the circulation state can be easily read. In S803, the environmental temperature, recording time, and the duty ratio of the recording may be acquired. Control based on this information will be described later.

In step S804, the main control unit 100 waits for a predetermined time. “wait” here refers to maintaining a state of executing the circulation of the ink for control, without performing the recording operation. In other words, in this step, the circulation control of ink is continued for 30 seconds in order to observe the state of the temperature change of the recording head. The 30 seconds wait time is an example, and the wait time is not limited to this.

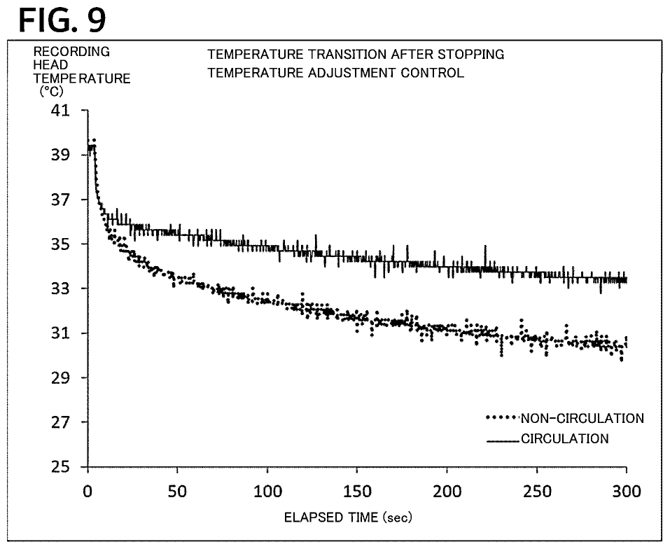

Here the temperature change in a case where circulation is normally operating and a case where circulation is not normally operating will be described. FIG. 9 is an image diagram depicting a recording head temperature change transition after the end of the recording operation according to Embodiment 1. The abscissa indicates the elapsed time, and the ordinate indicates the recording head temperature. The solid line is a graph in the case where the circulation is normally operating, and the dotted line is a graph in the case where the circulation is not operating (non-circulation). As indicated in FIG. 9, the inclination of the drop in temperature is gentle in the case where the circulation is normally operating, and the inclination of the drop in temperature is sharp in the case where the circulation is not operating.

The relationship in FIG. 9 is established because ink is circulated inside the recording head in Embodiment 1. In other words, the temperature modulation control and the circulation operation are performed for the recording operation, hence in the state after the end of the recording, not only ink in the vicinity of the ejection port 132 but also ink in the entire recording head is warmed. Normally if the temperature modulation control is stopped in the state where the circulation is stopping, the ink in the vicinity of the ejection port 132 quickly cools. In the state where the circulation is operating, on the other hand, the cooled ink quickly flows away from the recording element substrate where the temperature detection elements S1 to S9 exist, and moves into the upper part of the recording head, and ink of which temperature is still high flows around the temperature detection elements. Therefore in Embodiment 1, the inclination of the drop in temperature is gentler when the circulation is normally operating. However, as mentioned above, the circulation mode is not limited to Embodiment 1, hence this relationship between the circulation state and the temperature change may be changed depending on the circulation mode.

In step S805, the main control unit 100 acquired the recording head temperature again, after the predetermined time elapsed, as a second head temperature T2. This step corresponds to acquiring the second temperature information at a second timing which is later than the first timing. Then in step S806, the main control unit 100 determines whether a difference between the first head temperature T1 and the second head temperature T2 (T1-T2) is less than a threshold a. If the difference is less than the threshold (S806=YES), it is determined that circulation is normal, and processing advances to step S809, where circulation processing is stopped and the circulation detection operation is ended. If the difference is the threshold or more (S806=NO), on the other hand, it is determined that the circulation state is not normal, and processing advances to step S807 where the circulation processing is stopped, and then advances to S808 where recovery processing of the recording head is attempted, then the circulation detection operation is ended. In step S808, normal recovery processing may be performed, or recovery processing which is more effective than the normal recovery processing may be performed, recognizing that the detection result indicates that the circulation state is not normal, or notification that the circulation is abnormal (notification to the user, notification to request a visit by a service personnel (service call)) may be performed.

Here the threshold a, which is a temperature difference to determine the circulation state, may be set as a specified value, or may be determined based on various information. Various information includes, for example, the environmental temperature, the recording time, the duty ratio of the recording, and the like, which are acquired at the timing of S803. The environmental temperature is temperature information acquired by the thermistor 121. The recording time is recording time (operation time) in the previous recording operation, acquired with reference to the operation recording of the recording device 50, for example. The duty ratio of the recording is a value determined based on the print ratio in the image data, and may also be determined by analysis of the image data, or from the count value of the ejection dot counter 119. Instead of the duty ratio, the print ratio of the recording image or the ink amount may be used.

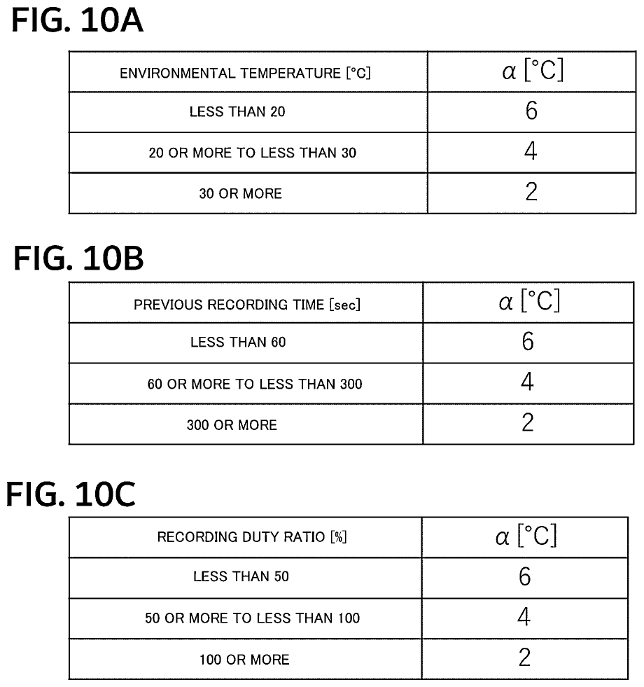

FIGS. 10A to 10C are tables to determine the threshold a based on the environmental temperature, the previous recording time, and the duty ratio of the recording of the image. The numeric values in each table are merely examples, and are not limited to these values.

In FIG. 10A, the threshold a is determined depending on the environmental temperature. As the environmental temperature is lower, the head temperature dropping speed becomes faster. Therefore the threshold a becomes a larger value as the environmental temperature is lower. In FIG. 10B, the threshold value α is determined depending on the previous recording time. As the recording time is longer, the influence of the stored heat remains longer, and the head temperature dropping speed becomes slower. Therefore the threshold value α becomes a smaller value as the recording time is longer. In FIG. 10C, the threshold value α is determined depending on the duty ratio of the recording of the image. As the duty ratio is higher, the attainment temperature, when the recording head temperature is rising, becomes higher, and the head temperature dropping speed becomes slower. Therefore the threshold value α becomes a smaller value as the duty ratio is higher.

Any one of the tables in FIGS. 10A to 10C may be used, or a plurality of tables may be used. In the case of using a plurality of tables, the value of the threshold a may be different depending on the table. In such a case, a largest value thereof may be used. Further, in the case of using a plurality of values of the threshold a, a mathematical formula including each value may be used, instead of a table. In this case, a mathematical formula which includes the environment temperature, the recording time, and the duty ratio as parameters is stored in the ROM 102 in advance.

### Modification

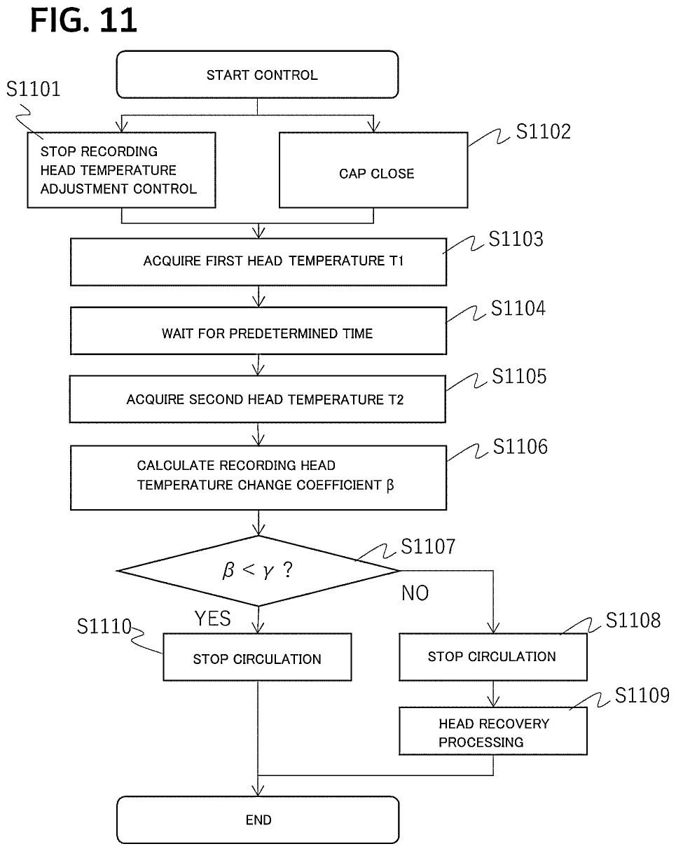

FIG. 11 is a flow chart according to a modification of Embodiment 1. In FIG. 8, the circulation state is determined based on the temperature of the recording head, but in FIG. 11, the circulation state is determined based on a relative change amount of the temperature. Description on a step the same as FIG. 8 will be omitted. In step S1106, the main control unit 100 divides a difference between the first head temperature T1 (temperature immediately after the temperature modulation control) and the second head temperature T2 (temperature after waiting 30 seconds) by time. Thereby a coefficient β[° C./sec], to indicate the temperature change per unit time can be calculated

$$( β = ( T 2 - T 1 ) / 30 [ ° C . / sec ] ) .$$

In step S1107, the main control unit 100 compares the temperature relative change coefficient β and a specified value γ, to detect the circulation state. In other words, in a case where the temperature relative change coefficient β is less than the specified value γ (S1107=YES), this means that the temperature change per unit time is relatively small, and the main control unit 100 determines that the circulation is normal, stops the circulation and ends the detection, just like S809 in FIG. 8. In a case where the temperature relative change coefficient β is the specified value γ or more (S1107=NO), on the other hand, processing advances to step S1108 where the circulation processing is stopped, and processing advances to step S1109 where head recovery processing is performed.

As described above, according to Embodiment 1, the circulation state of the nozzle can be detected based on the temperature change of the recording head after the end of the recording operation. If it is determined that the circulation state is not normal, the recovery processing, error notification, service call, or the like is performed, so as to prevent a state where the viscosity of the ink around the ejection port increases and an ejection failure is generated.

### Embodiment 2

Embodiment 2 will be described next focusing on a content different from Embodiment 1. In Embodiment 1, the circulation state is detected after the end of the recording operation, but in Embodiment 2, the same detection is also performed before starting the recording operation.

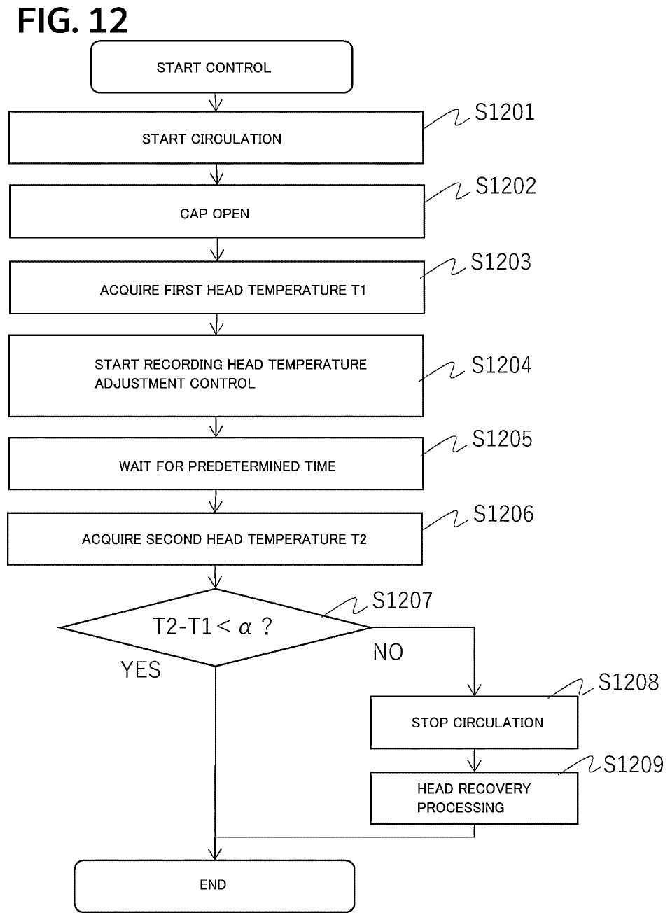

FIG. 12 is a flow chart of a circulation detection operation sequence which is performed by the main control unit 100. This flow chart is started after the main control unit 100 receives the recording start signal. Description not especially mentioned here indicates a same configuration or a same processing as Embodiment 1. In step S1201, the main control unit 100 starts circulation of the recording head. In step S1202, the main control unit 100 sets the cap member to a cap open state. In step S1203, the main control unit 100 acquires the first head temperature T1 of the recording head 9. The environmental temperature may also be acquired at this timing.

In step S1204, the main control unit 100 starts the temperature adjustment control of the recording head 9. In step S1205, the main control unit 100 waits for a predetermined time. The duration of the time is not especially limited, and may be one second, for example. In step S1206, the main control unit 100 acquires the second head temperature T2 again after the predetermined time elapsed.

In step S1207, the main control unit 100 calculates the difference between the first head temperature T1 and the second head temperature T2, and compares this difference with a predetermined threshold (T2-T1<α?). In a case where the difference is less than the threshold a (S1207=YES), the main control unit 100 determines that the circulation is normal, and starts the recording operation. In a case where recording has not yet started, the main control unit 100 detects the circulation state based on the amount of change of the temperature increase up to reaching the target temperature by the temperature adjustment control in the predetermined time. If the circulation is operating normally, ink in the cool state sequentially flows around the temperature detection elements, and it is determined that ink of which temperature change is gentle is circulating, just like Embodiment 1. In a case where the temperature difference is the threshold or more (S1207=NO), on the other hand, the main control unit 100 determines that the circulation state is not normal, and processing advances to S1208 where the circulation processing is stopped, then the recording head recovery processing and the like is attempted, and the circulation detection operation is ended.

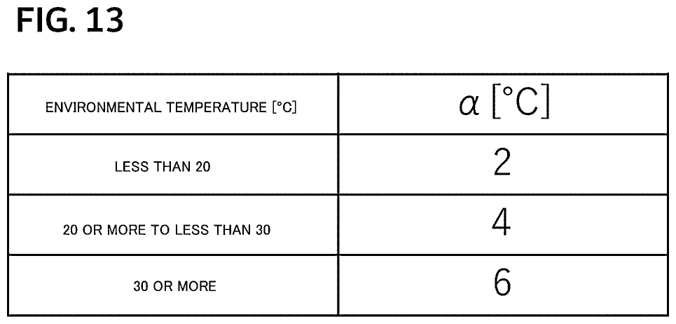

For the threshold a to determine the circulation state, a specified value stored in the ROM 102 in advance may be used. Further, in the case where the environmental temperature was acquired by the thermistor 121 in S1203, the threshold a may be determined based on the acquired environmental temperature, with reference to such a table as the table indicated in FIG. 13. In the case of Embodiment 2, the detection is performed before starting the recording, hence the previous recording time and the duty ratio of the recording of the image are not used. The threshold a in the table in FIG. 13 decreases as the environmental temperature is lower, since the head temperature rising speed decreases as the environmental temperature decreases.

### Embodiment 3

Embodiment 3 will be described next focusing on a content different from Embodiments 1 and 2. In Embodiment 3, the circulation state detection control is not performed in a case where the non-recording time from the end of the previous recording operation does not exceed a predetermined time. In Embodiment 3, the influence of heat storage due to the previous recording operation is eliminated, and detection errors can be prevented.

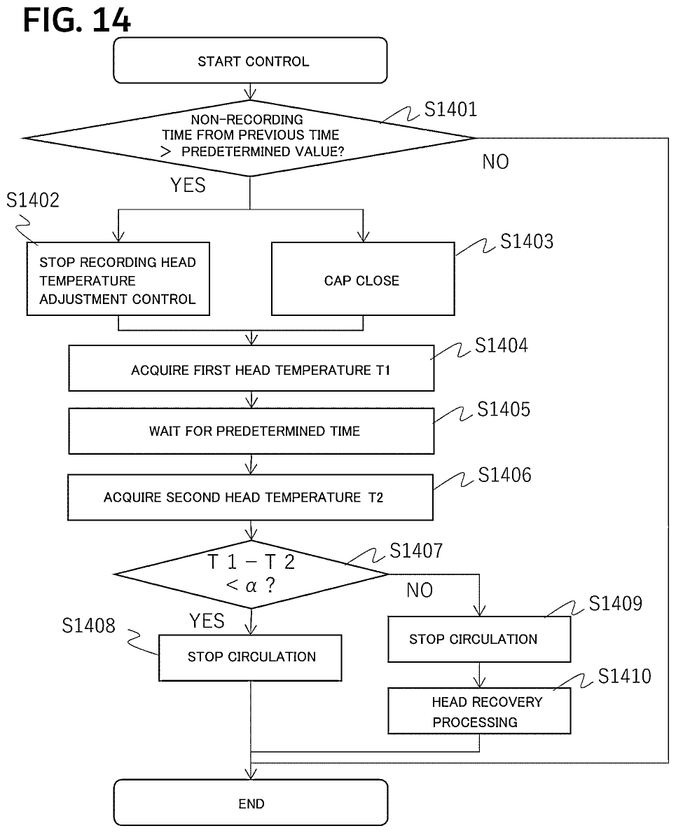

FIG. 14 is a flow chart indicating details of processing performed by the main control unit 100. The sections which are not especially described here are a same configuration or a same processing as Embodiments 1 and 2.

In step S1401, if the non-recording time from the previous time is longer than a predetermined time (20 minutes, for example, but is not limited to this time) (S1401=YES), the main control unit 100 advances processing to S1402 and S1403, and performs the circulation state detection control. The content of the circulation state detection control is the same as Embodiment 1. If the non-recording time is the predetermined time or less (S1401=NO), on the other hand, control is ended.

According to Embodiment 3, a detection error, due to determining the circulation state before the predetermined time elapses, can be prevented. FIG. 14 is an example of determining whether or not the circulation state detection control is needed, as described in Embodiment 1, but is also applicable to the circulation state detection control before starting the recording operation, as described in Embodiment 2.

### Embodiment 4

Embodiment 4 will be described next focusing on a content different from Embodiments 1 to 3. The steps not described here can be executed in the same manner as Embodiment 2. In Embodiment 4, the circulation state detection control is performed, not before and after the recording operation, but after the recovery processing is performed. In Embodiment 4, the ink around the ejection port is discharged by the recovery processing, and is replaced with new and cold ink supplied from the ink tank. As a result, the influence of the stored heat can be sufficiently eliminated, and a detection error can be prevented.

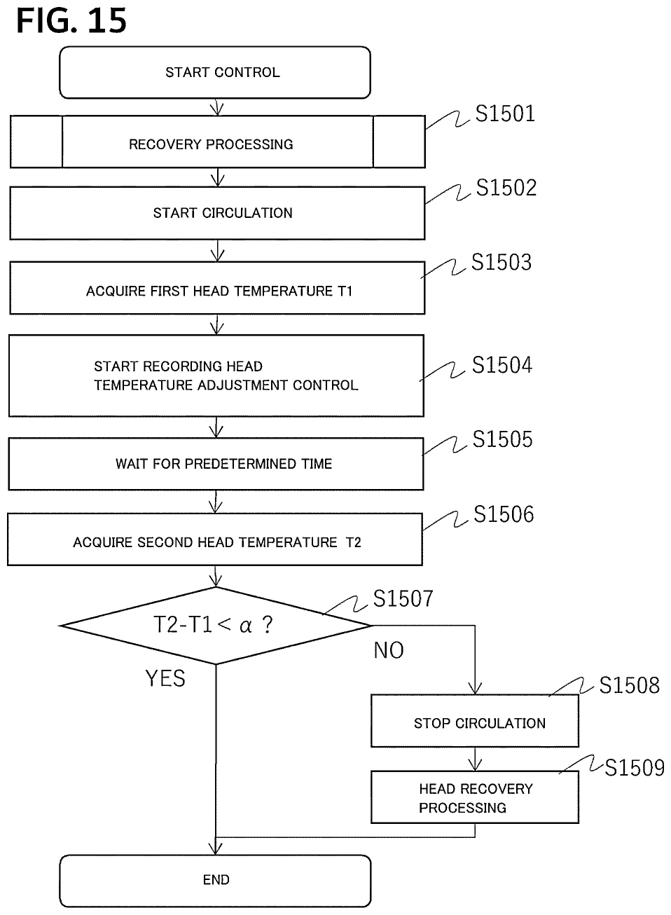

FIG. 15 is a flow chart indicating details of processing performed by the main control unit 100. In step S1501, the recovery processing is performed. The method for the recovery processing is not especially limited, but a method in which the ink replacement ratio is higher is better in terms of eliminating the influence of stored heat. In step S1502, the circulation is started. Hereafter the circulation state detection control described in Embodiment 2 is performed. According to Embodiment 4, the circulation state after performing the recovery processing can be detected so that the effect of the recovery processing can be recognized, and a detection error can also be prevented.

As described above, according to the configuration of each embodiment, it can be determined whether the ink circulation state inside the recording head is normal. Therefore even when an insufficient circulation state is detected, processing inside the recording head and the ink circulation can be performed normally, and the influence of an increase in viscosity of the ink on the ejection port can be suppressed, and recording can be performed normally.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017443, filed on Feb. 7, 2024, which is hereby incorporated by reference wherein in its entirety.

What is claimed is:

1. A recording device, comprising:
a recording head that includes an ejection port configured to eject ink, and a pressure chamber filled with ink to be ejected from the ejection port, and performs recording operation by ejecting ink from the ejection port;
a circulation unit configured to perform circulation operation to circulate ink through a circulation path including the pressure chamber; and
a control unit, wherein
the control unit
acquires temperature information, which is information on temperature of the recording head, in a state where the circulation unit is performing the circulation operation, and
determines a circulation state of the ink in the circulation path, based on the information on the temperature.

2. The recording device according to claim 1, wherein
the control unit
acquires first temperature information, which is the temperature information at a first timing, and second temperature information, which is the temperature information at a second timing which is after the first timing, in a state where the circulation unit is performing the circulation operation, and
determines the circulation state of the ink in the circulation path by comparing a difference between the first temperature information and the second temperature information with a threshold.

3. The recording device according to claim 2, wherein
the control unit determines that the circulation state is normal in a case where the difference between the first temperature information and the second temperature information is less than the threshold.

4. The recording device according to claim 2, wherein
in a case where the difference between the first temperature information and the second temperature information is at least the threshold, the control unit determines that the circulation state is not normal, and performs recovery processing of the recording head, or performs notification on the state of the recording head.

5. The recording device according to claim 1, wherein
the control unit
acquires first temperature information, which is the temperature information at a first timing, and second temperature information, which is the temperature information at a second timing which is after the first timing, in a state where the circulation unit is performing the circulation operation, and
determines the circulation state of the ink in the circulation path by calculating a coefficient to indicate a temperature change per unit time, based on the first temperature information and the second temperature information, and comparing the coefficient with a threshold.

6. The recording device according to claim 5, wherein
the control unit determines that the circulation state is normal in a case where the coefficient is less than the threshold.

7. The recording device according to claim 5, wherein
in a case where the coefficient is at least the threshold, the control unit determines that the circulation state is not normal, and performs recovery processing of the recording head or performs notification of the state of the recording head.

8. The recording device according to claim 1, wherein
the circulation unit performs the circulation operation to circulate ink through the circulation path at the time of performing of the recording operation, and
the control unit determines the circulation state after performing the recording operation using the recording head.

9. The recording device according to claim 8, wherein
the control unit does not determine the circulation state before a predetermined time elapses after the recording operation.

10. The recording device according to claim 1, wherein
the control unit determines the circulation state after performing recovery processing of the recording head.

11. The recording device according to claim 1, wherein
the control unit determines the circulation state before performing the recording operation using the recording head.

12. The recording device according to claim 2, wherein
the threshold is a specified value determined in advance.

13. The recording device according to claim 2, wherein
the threshold is a value determined based on at least any of environmental temperature of the recording device, recording time of the recording operation immediately before determining the circulation state of the ink, and ink applying amount in the recording operation immediately before determining the circulation state of the ink.

14. The recording device according to claim 1, wherein
the recording head includes a plurality of temperature detection elements on a substrate in which the ejection port are formed, and
the control unit acquires, as the temperature information, a maximum value of detection values by the plurality of temperature detection elements.

15. The recording device according to claim 1, wherein
the recording head includes a plurality of temperature detection elements on a substrate in which the ejection port are formed, and
the control unit acquires, as the temperature information, a detection value by a temperature detection element close to the ejection port, out of the detection values by the plurality of temperature detection elements.

16. The recording device according to claim 1, wherein
the circulation unit includes a pump that is driven by the control unit.

17. The recording device according to claim 1, wherein
the recording head includes an ejection element configured to generate energy for liquid to be ejected from the ejection port, and
the pressure chamber is an area facing the ejection element.
